(19) United States
(12) Patent Application Publication
(10) Pub. No.: US 2006/0164968 A1
(43) Pub. Date: Jul. 27, 2006

(54) Method and apparatus for transmitting data in a diversity communication system employing constellation rearrangement with qpsk modulation

(75) Inventors: Alexander Golitschek Edler Von Elbwart, Darmstadt (DE); Christian Wengerter, Kleinheubach (DE)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial Co. , Ltd., Osaka (JP)

(21) Appl. No.: 10/538,934

(22) PCT Filed: Dec. 23, 2002
(86) PCT No.: PCT/EP02/14744

§ 371 Date: Dec. 21, 2005

(51) Int. Cl. H04J 15/00

(52) U.S. Cl. 370/202

(57) ABSTRACT

A method of transmitting data from a transmitter to a receiver of a diversity (e.g. ARQ or reptetition coding) communication system comprising the step of encoding data received from a signal source to generate a Galois field (GF) symbols (101). The method further comprises the steps of modifying redundant GF symbols by an arithmetic operation (102) mapping the GF symbols using QPSK as modulation scheme (104) and transmitting the QPSK modulation symbols and the modified redundant symbols (105) to the receiver. Furthermore, the invention concerns a corresponding transmitter of a diversity communication system.

The present invention generally relates to signal constellation rearrangement schemes. This technique is applicable in communication systems that provide ARQ mechanisms or in systems that provide diversity by transmitting redundancy within the same data unit. It is in particular suitable for systems that employ QPSK as modulation scheme.

The invention can also be applied in a communication system where redundancy is transmitted simultaneously, e.g. via multiple diversity branches for example transmit antennas, or within the same data packet. In the following this is generally referred to as “diversity”.

In G. Benelli, “New mapping rules for combination of M-ary modulation and error-detecting codes in ARQ systems”, IEE Proceedings, Vol. 137, Pt. I, No. 4, August 1990, it is shown and proven that increasing the euclidean distances between signal constellation points more than linearly results in improved performance. This is particularly valid when identical data is to be repeated either by using multiple packet transmissions, or by repeating identical data within the same packet with different constellations.

To this end, there exist different mapping methods of symbols onto constellation points. These methods depend then for example on the transmission number of a packet. The behaviour can be seen as illustrated in FIG. 3A to FIG. 3C. In these, identical input symbols (“0”, “1”, “2”, “3”) are mapped onto different signal constellation points in first, second, and third transmission respectively.

For binary communication systems, the binary mathematic involved follows the rules of finite fields with 2 elements, also called Galois Field of order two or GF(2) in short.

The operations and rules for Galois Fields exist however for other orders than two. Details on this can be found for example in S. Lin, D. J. Costello Jr., “Error Control Coding: Fundamentals and Applications”, Prentice-Hall, 1983, pages 29-33. Here it is sufficient to note that additions and multiplications are defined in a straightforward way.

In the present invention, the multiplication of GF(4) elements is of particular interest. Therefore two important properties are given here without proof:
For two elements of GF(4) a and b, b is a so-called null-element, if
   a·b=b (1)
   holds for any a.
For two elements of GF(4) a and b, b is a so-called identity-element, if
   a·b=a (2)
   holds for any a.

As described above, the prior art is so far realised through a parameterised input symbol to symbol mapping entity. The present invention aims for efficient implementational reasons to provide a method and transmitter using a non-parameterised standard mapping entity.

According to a present invention, there is provided a method and a transmitter for transmitting data as set forth by the independent claims. The general idea underlying the present invention is to modify in the transmitter the redundant retransmitted data symbols by an arithmetic operation to have the beneficial effects of increased euclidean distances.

According to a preferred embodiment of the invention, an input symbol sequence is modified by a multiplicator that operates over a Galois Field GF(4), which is dependent on the diversity number parameter, prior to entering the symbols into the mapping entity 105. The resulting output sequence is then indistinguishable from the output of the mapping entity operating with a plurality of mapping schemes.

In the following the invention will be described in further detail with reference to the accompanying drawings in which

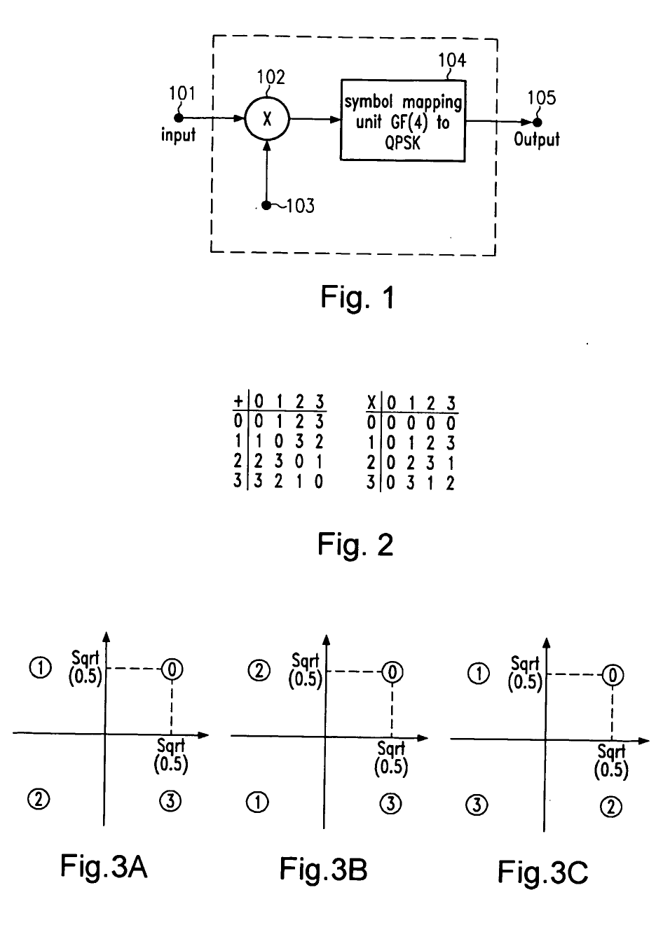

FIG. 1 illustrates the principal structure for an implementation of the transmitter according to the present invention;

FIG. 2 illustrates addition and multiplication operations in GF(4) arithmetics;

FIGS. 3A-3C show 3 sample symbol mapping rules;

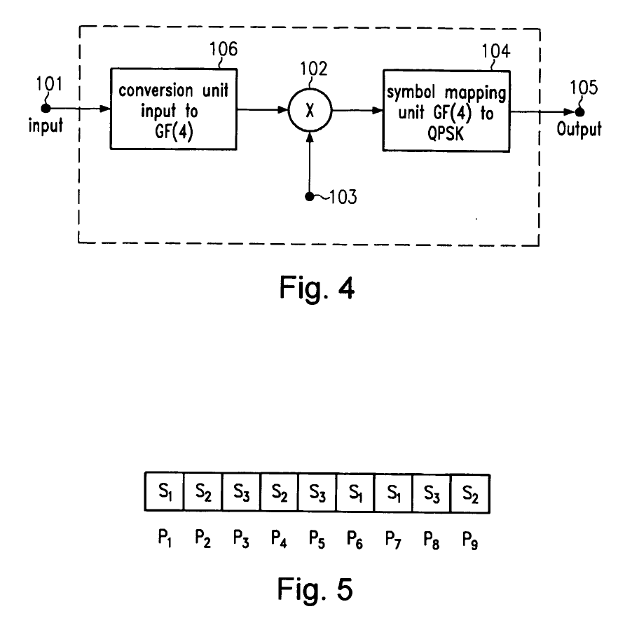

FIG. 4 shows an alternative embodiment of the transmitter;

FIG. 5 illustrates an example for a packet transmission method according to the present invention.

The present invention computes a rearranged QPSK symbol for a given input symbol. Since in QPSK there are four distinguishable modulation symbols, we can identify these with the four distinct elements of GF(4), for convenience labelled “0”, “1”, “2”, “3”. Referring to equations (1) and (2), “0” is the null-element and “1” is the identity-element. Also for simplicity we assume that the input symbols consist of GF(4) elements, using the same labelling.

According to FIG. 1, the necessary parts of a transmitter for illustrating the present invention are shown. In more detail, the transmitter comprises an input portion 101, which receives data symbols from a signal source (not shown). The input portion can e.g. implemented by a data encoding unit to generate Galois field symbols.

A multiplicator 102 computes the multiplication of the input symbols with a diversity parameter m 103, which itself is defined as an element of GF(4). In that way, modified redundant data symbols having the identical information as previously generated symbols are obtained.

After multiplication, the input symbols are applied to the symbol mapping unit 104 employing QPSK as modulation scheme. Finally, a transmitting unit, symbolized by output portion 105, transmits the QPSK modulated GF symbols and the modified redundant GF symbols over a wired or wireless channel to the receiver of the communication system.

The arithmetic operations within GF(4) are usually defined by a primitive polynomial For the outline of this description, we assume this polynomial to be
g(a)=1+a+a² (3)

If an ARQ system consisting of retransmissions is concerned, m can be derived from the transmission number. Let t identify the transmission number of a packet, starting at 1. Then m can be computed as
m=(t mod 3)+1 (4)

The preferred embodiment of the multiplicator 102 consists of a two-dimensional lookup-table, similar to the right part of FIG. 2.

With these presumptions it is easy to prove for those skilled in the art that the output portion 105 achieves the same distance properties as the concept of applying different mapping rules. Therefore the symbol mapping unit 104 can follow one of the mappings of FIGS. 3A to 3C consistently and independently of the diversity parameter.

As an alternative to the lookup-table implementation, another form is based upon polynomial calculations, as outlined in S. Lin, D. J. Costello Jr., “Error Control Coding: Fundamentals and Applications”, Prentice-Hall 1983, pages 29-33.

In brief, each element of GF(4) is represented by a polynomial. Multiplications of GF(4) elements are therefore translated into polynomial multiplications. Then the primitive polynomial (see equation (3)) combined with addition properties of GF(4) can be used to reduce the resulting polynomial, such that in the end the resultant polynomial can be translated back into the corresponding GF(4) element.

Similarly, the whole representation of GF(4) elements and the corresponding QPSK symbols can be changed to polynomial representation or power representation (see S. Lin, D. J. Costello Jr., “Error Control Coding: Fundamentals and Applications”, Prentice-Hall 1983 on page 33, Table 2.8 for an example of GF(16)). Likewise, the representation can be any distinguishable set of characters/number/etc., as these are only abstractions for math theory, and do not change the underlying operations and properties.

As an example, instead of “0”, “1”, “2”, “3” the representation could also be “7”, “a”, “□”, “*”.

If binary communication systems are employed, then typically these binary symbols (“bits”) are represented as “0” or “1”, i.e. GF(2). In such a case, a modified block diagram of the transmitter portion is shown in FIG. 4.

Prior to GF(4) multiplication a converter 106 of two GF(2) symbols into one GF(4) symbol is necessary. Generally this mapping is arbitrary. The preferred embodiment for this is given in Table 1. It should be emphasized that other mappings are possible, as long as they are unambiguous and are used consistently.

TABLE 1

| GF(2) | GF(4) |
|---|---|
| input | output |
| symbols | symbol |
| 00 | 0 |
| 01 | 1 |
| 10 | 2 |
| 11 | 3 |

Likewise, a similar conversion rule can be defined for any input alphabet that has a cardinality of a power of two, possibly with the need to split one input symbol into multiple output symbols (i.e. two input GF(8) symbols could be mapped into three output GF(4) symbols).

Again, it should be stated that the representation of GF(4) symbols is exemplary.

The example given in equation (4) above is the preferred implementation. However, other algorithms can be devised to the same end.

The criteria for finding a suitable diversity parameter m are:
m shall never be the null-element
m shall change when a data element is transmitted for the non-first time
An element of GF(4) shall not be used for m while any other element of GF(4) except the null-element has not been used less often.

As an example for the latter rule, an element that has already been used 2 times so far shall not be reused while any other element has not been used for 2 times.

Generally, m should only be changed when the data to be transmitted has already been sent before. As an example, FIG. 5 shows a very simple data packet consisting of nine GF(4) symbols sᵢ, i=1 . . . 3 in positions p₁ . . . p₉. For the symbols in positions p₁, p₂, p₃ the value of m can be set to 1. In positions p₄, p₅, p₆, there are symbols which had already been transmitted, therefore the value of m should now be changed for example to 2. Similarly in positions p₇, p₈, p₉ the value of m should change again, now to the GF(4) symbol 3. If afterwards any of the symbols s₁, s₂, s₃ is transmitted again, m can be chosen again freely of the three non-null elements of GF(4).

It is important to note that the change of m shall only take place if the data to be transmitted carries the same information, in other words if the data is repetitive. It is not meant to say that m should change whenever e.g. the GF(4) symbol 2 is transmitted. The procedure outlined above is only meaningful if the underlying information of the symbol is identical.

As an example for applicability of the present invention take a repetition code of rate ½, where each information symbol is transmitted twice for improved error resilience. Other examples should be easy to identify for those skilled in the art of diversity transmissions, e.g. ARQ.

1. A method of transmitting data from a transmitter to a receiver of a diversity communication system comprising the steps of:
encoding data received from a signal source to generate Galois field (GF) symbols;
modifying redundant GF symbols by an arithmetic operation;
mapping the GF symbols and the modified redundant GF symbols using QPSK as modulation scheme; and
transmitting the QPSK modulation symbols and the modified redundant QPSK symbols to the receiver.

2. The method according to claim 1, wherein the step of modifying redundant GF symbols comprises multiplying an input data symbol sequence with a multiplier.

3. The method according to claim 2, wherein the multiplier is dependent on a diversity parameter.

4. The method according to one of claims 1 to 3, wherein the GF symbols are obtained by an operation over a GF(4) field with four elements.

5. The method according to claim 4, wherein the input GF symbols are converted to GF(4) symbols prior to applying the arithmetic operation.

6. The method according to claims 1 to 5, wherein the arithmetic operation is defined by a primitive polynominal.

7. The method according to claim 3, wherein the diversity parameter is changed when data to be transmitted carries the same information that have already been sent to the receiver.

8. The method according to claims 1 to 7, wherein the redundant modified QPSK symbols are transmitted within the same data packet with the QPSK modulation symbols.

9. The method according to claims 1-8, wherein the redundant modified QPSK symbols are transmitted over multiple diversity branches.

10. A transmitter of a diversity communication system comprising:
a data encoding unit (101) for generating GF symbols,
a modifying unit (102) for generating modified redundant GF symbols using an arithmetic operation;
a mapping unit (104) for mapping the GF symbols and the modified redundant GF symbols using QPSK as modulation scheme; and
a transmitting unit (105) for transmitting the QPSK modulated GF symbols and the modified redundant QPSK symbols.

11. The transmitter according to claim 10, wherein the modifying unit (102) is a multiplicator (102) for multiplying the GF symbols with a multiplier.

12. The transmitter according to claim 10 or 11, wherein the multiplicator is a look-up table according to which the input GF symbols are modified using a diversity parameter.

13. The transmitter according to one of claims 10 to 12, wherein the transmitter is an ARQ transmitter for sending redundancy versions of already sent data symbols having identical information.
